(19) United States
(12) Patent Application Publication
(10) Pub. No.: US 2014/0281568 A1
(43) Pub. Date: Sep. 18, 2014

(54) Using Biometrics to Generate Encryption Keys

(71) Applicant: Google Inc., Mountain View, CA (US)

(72) Inventors: Steven Ross, Mountain View, CA (US); Henry Will Schneiderman, Mountain View, CA (US)

(21) Appl. No.: 13/838,273

(22) Filed: Mar. 15, 2013

(51) Int. Cl. G06F 21/32

(52) U.S. Cl. CPC G06F 21/32
USPC 713/186

(57) ABSTRACT

An electronic device may be used to support user authentication based on biometric readings. In this regard, a unique identification parameter may be generated for each user associated with the electronic device. The unique identification parameter may comprise a user identification input parameter (e.g., alphanumerical password) combined with a set of values (e.g., alphanumerical) generated based on biometrics data generated for the user. In this regard, the biometric based values may be generated based on configuring, for each possible biometric identifier, a range of valid values, such as based on a type of biometric identifier and a specified degree of accuracy. User access may be permitted based on obtaining of a subsequent biometric reading, and generating based thereon a second identification parameter that is compared with the unique identification parameters recognized by the electronic device.

### TECHNICAL FIELD

Aspects of the present application relate to distribution of content. More specifically, certain implementations of the present disclosure relate to using biometrics to generate encryption keys.

### BACKGROUND

Various types of electronic devices are commonly used nowadays. In this regard, electronic devices may be used by one or more users, for various purposes, including both personal (e.g., leisure related activities or personal transactions) and commercial (e.g., business related activities or transactions). Electronic devices may be mobile or non-mobile, may (or not) support communication (wired and/or wireless) to and/or from the devices, and/or may be general or special purpose devices. Examples of electronic devices may comprise handheld mobile devices (e.g., cellular phones, smartphones, and/or tablets), computers (e.g., laptops, desktops, and/or servers), and/or other similar devices. In some instances, the electronic devices may be utilized in accessing data or content, which may sometimes be stored or maintained external to the electronic devices themselves—e.g., being stored in other systems or devices that may be accessed by the electronic devices, and/or retrieved therefrom, such as in the form of web access.

Because of the functions, operations, activities and/or transactions that may be performed in or by the electronic devices, these devices may contain or allow access to confidential, valuable and/or personal information. For example, users may use particular electronic devices (e.g., smartphones or tablets) for shopping, planning and/or scheduling personal and/or professional appointments, conducting financial transactions (e.g., banking), and/or conducting business or other professional interactions (e.g., emails). Accordingly, guarding against unwanted access to electronic devices, and/or any data or content access in or through the electronic devices, is becoming more and more important, and use of reliable access mechanisms may be desired.

Further limitations and disadvantages of conventional and traditional approaches will become apparent to one of skill in the art, through comparison of such approaches with some aspects of the present method and apparatus set forth in the remainder of this disclosure with reference to the drawings.

### BRIEF SUMMARY

A system and/or method is provided for using biometrics to generate encryption keys, substantially as shown in and/or described in connection with at least one of the figures, as set forth more completely in the claims.

These and other advantages, aspects and novel features of the present disclosure, as well as details of illustrated implementation(s) thereof, will be more fully understood from the following description and drawings.

### BRIEF DESCRIPTION OF SEVERAL VIEWS OF THE DRAWINGS

FIG. 1 is a block diagram illustrating an electronic device that may support generation of unique access parameters based on biometric data.

FIG. 2 is a block diagram illustrating an example of interactions while controlling access to an electronic device using unique access parameters that are generated based on biometric data.

FIG. 3 is a block diagram illustrating different ways for combining user-input and biometrics based data when generating access parameters.

FIG. 4 is a flow chart that illustrates a process for generating a user-specific, unique access parameter that may be used in secure access.

FIG. 5 is a flow chart that illustrates a process for secure access based on biometric data and user-input.

### DETAILED DESCRIPTION

The present disclosure relates to a method and system for using biometrics to generate encryption keys. In various implementations, an electronic device may be utilized to support secure access by enabling generation and/or use of user-specific, biometric based access parameters. In this regard, the electronic device may obtain biometrics related data associated with a user, where the biometrics related data comprises a plurality of biometric identifiers that uniquely identify the user. The electronic device may then generate a plurality of biometric based values, where the plurality of biometric based values may be generated based on assigning of an associated value to each of the plurality of biometric identifiers in the obtained biometric data. For each of the plurality of biometric identifiers, a range of valid values is defined based on a type of biometric identifier and a specified degree of accuracy for the biometric identifier. The electronic device may then configure, based on the assigned associated values corresponding to the plurality of biometric identifiers, a secure access parameter associated with the user, which (the secure access parameters) may be used in granting access to data using the electronic device. The secure access parameter may comprise at least a first portion that comprises at least one of the plurality of biometric based values and a second portion that is based on a user identification input. The secure access parameter may comprise an encryption key that is used in encrypting and decrypting data access in or through the electronic device. The user identification input may comprise a password, for example.

Each of the plurality of biometric identifiers may correspond to a biometric feature or a characteristic associated with a biometric feature. In some instances, the first portion and the second portion of the secure access parameter are concatenated. Alternatively, the first portion and the second portion of the secure access parameter may be hashed and/or interleaved—i.e. values (e.g., bits) corresponding to each of the portions may be mixed up within the secure access parameters, such as based on pre-determined pattern or manner associated with the user.

When determining whether to grant access (or not), to a person requesting access to the electronic device, the electronic device may obtain second biometrics related data associated with the person requesting access to the electronic device. The electronic device may then generate a requester access parameter based on the second biometrics related data, where the requester access parameter may comprise a plurality of values corresponding to one or more of a plurality of biometric identifiers in the second biometrics related data and an input parameter provided by the person. The electronic device may then use the requester access parameter in determining when to grant access—e.g., based on comparing of the requester access parameter with the secure access parameter, either using direct comparison (i.e. parameter vs. parameter), or indirectly, such as by using the request identification parameter in attempting to access functions or data that is protected with the secure access parameter.

In some instances, the electronic device may be configured to allow for some measure of dissimilarity for the comparing of the requester access parameter with the secure access parameter. For example, the electronic device may allow for a maximum measure of dissimilarity, which may be determined, as least in part, based on the specified degree of accuracy associated with each biometric identifier. The granting of access to the electronic device may comprise enabling access to data stored in or access via the electronic device. In this regard, the enabling of access to data stored in or access via the electronic device comprises enabling decryption of the data when the data is encrypted—e.g., encrypting the data using the secure access parameter, and attempting to decrypt the encrypted data using the requester access parameter.

As utilized herein the terms “circuits” and “circuitry” refer to physical electronic components (i.e. hardware) and any software and/or firmware (“code”) which may configure the hardware, be executed by the hardware, and or otherwise be associated with the hardware. As utilized herein, “and/or” means any one or more of the items in the list joined by “and/or”. As an example, “x and/or y” means any element of the three-element set {(x), (y), (x, y)}. As another example, “x, y, and/or z” means any element of the seven-element set {(x), (y), (z), (x, y), (x, z), (y, z), (x, y, z)}. As utilized herein, the terms “block” and “module” refer to functions than can be performed by one or more circuits. As utilized herein, the term “e.g.,” introduces a list of one or more non-limiting examples, instances, or illustrations.

FIG. 1 is a block diagram illustrating an electronic device that may support generation of unique access parameters based on biometric data. Referring to FIG. 1 there is shown an electronic device 100.

The electronic device 100 may comprise suitable circuitry, interfaces, logic, and/or code for implementing various aspects of the disclosure. For example, the electronic device 100 may be configured to perform, execute or run various operations, functions, applications and/or services. The electronic device 100 may, for example, perform, execute and/or run operations, functions, applications and/or services based on user instructions and/or pre-configured instructions. According, in some instances the electronic device 100 may be configured to support or enable (e.g., by use of suitable input/output devices or components) interactions with users, such as to obtain user input and/or to provide user output. Some of the operations, functions, applications and/or services performed, executed or run by the electronic device 100 may require communicating of data from and/or the electronic device 100. According, in some instances the electronic device 100 may be configured to support communication of data, such as via wired and/or wireless connections, in accordance with one or more supported wireless and/or wired protocols or standards. In some instances, the electronic device 100 may be a handheld mobile device—i.e. intended for use on the move and/or at different locations. In this regard, the electronic device 100 may be designed and/or configured to allow for ease of movement, such as to allow it to be readily moved while being held by the user as the user moves, and the electronic device 100 may be configured to perform at least some of the operations, functions, applications and/or services supported by the device on the move. Examples of electronic devices may comprise handheld devices (e.g., cellular phones, smartphones, and/or tablets), computers (e.g., laptops or desktops), servers, dedicated multimedia devices (e.g., game consoles and portable media players), and/or other similar devices. The disclosure, however, is not limited to any particular type of electronic device.

In an example implementation, the electronic device 100 may comprise a main processor 102, a system memory 104, a communication subsystem 110, an input/output (I/O) subsystem 120, an access manager 130, and a biometric reading subsystem 140.

The main processor 102 may comprise suitable circuitry, interfaces, logic, and/or code that may be operable to process data, and/or control and/or manage operations of the electronic device 100, and/or tasks and/or applications performed therein. In this regard, the main processor 102 may configure and/or control operations of various components and/or subsystems of the electronic device 100, by utilizing, for example, one or more control signals. The main processor 102 may enable running and/or execution of applications, programs and/or code, which may be stored, for example, in the system memory 104. Alternatively, one or more dedicated application processors may be utilized for running and/or executing applications (or programs) in the electronic device 100.

The system memory 104 may comprise suitable circuitry, interfaces, logic, and/or code that may enable permanent and/or non-permanent storage, buffering, and/or fetching of data, code and/or other information, which may be used, consumed, and/or processed. In this regard, the system memory 104 may comprise different memory technologies, including, for example, read-only memory (ROM), random access memory (RAM), Flash memory, solid-state drive (SSD), and/or field-programmable gate array (FPGA). The system memory 104 may store, for example, configuration data, which may comprise parameters and/or code, comprising software and/or firmware.

The communication subsystem 110 may comprise suitable circuitry, interfaces, logic, and/or code operable to communicate data from and/or to the electronic device, such as via one or more wired and/or wireless connections. The communication subsystem 110 may be configured to support one or more wired protocols and/or interfaces, and/or one or more wireless protocols and/or interfaces, facilitating transmission and/or reception of signals to and/or from the electronic device 100 and/or processing of transmitted or received signals in accordance with applicable wired or wireless protocols. Examples of wireless protocols or standards that may be supported and/or used by the communication subsystem 110 comprise wireless personal area network (WPAN) protocols, such as Bluetooth (IEEE 802.15); near field communication (NFC) standards; wireless local area network (WLAN) protocols, such as WiFi (IEEE 802.11); cellular standards, such as 1G/2G+ (e.g., GSM/CPRS/EDGE, and IS-95 or cdmaOne) and/or 1G/2G+ (e.g., CDMA1000, UMTS, and HSPA); 4G standards, such as WiMAX (IEEE 802.16) and LTE; Ultra-Wideband (UWB), and/or the like. Examples of wired protocols and/or interfaces that may be supported and/or used by the communication subsystem 110 comprise Ethernet (IEEE 802.2), Fiber Distributed Data Interface (FDDI), Integrated Services Digital Network (ISDN), and Universal Serial Bus (USB) based interfaces. Examples of signal processing operations that may be performed by the communication subsystem 110 comprise, for example, filtering, amplification, analog-to-digital conversion and/or digital-to-analog conversion, up-conversion/down-conversion of baseband signals, encoding/decoding, encryption/decryption, and/or modulation/demodulation.

The I/O subsystem 120 may comprise suitable circuitry, interfaces, logic, and/or code for enabling and/or managing user interactions with the electronic device 100, such as obtaining input from, and/or to providing output to, the device user(s). The I/O subsystem 120 may support various types of inputs and/or outputs, including, for example, video, audio, and/or text. In this regard, dedicated I/O devices and/or components, external to (and coupled with) or integrated within the electronic device 100, may be utilized for inputting and/or outputting data during operations of the I/O subsystem 120. Examples of such dedicated I/O devices may comprise displays, audio I/O components (e.g., speakers and/or microphones), mice, keyboards, touch screens (or touchpads), and the like. In some instances, user input obtained via the I/O subsystem 120, may be used to configure and/or modify various functions of particular components or subsystems of the electronic device 100.

The access manager 130 may comprise suitable circuitry, interfaces, logic, and/or code for managing access related operations in the electronic device 100. In this regard, the access manager 130 may be configured to, for example, support and/or manage authentication or validation of user and/or access related activities associated with users (e.g., when a user attempts to gain access to electronic device 100, data available in or through the electronic device 100, and/or other systems or devices that may be accessed via the electronic device 100). In an example implementation, the access related control in the electronic device 100 may be based on biometrics. In this regard, biometric based data may be utilized to generate and/or configured user-unique access related parameters. For example, biometric related data may be utilized to generate encryption keys, which may be utilized in encrypting data accessed via the electronic device 100, and/or to decrypted previously-encrypted data. To aid in performing access related functions, the access manager 130 may be operable to obtain user related information pertinent to authentication of users or actions thereof, such as by using the I/O subsystem 120 (e.g., user input, such as selection or typing) and/or the biometric reading subsystem 140 (e.g., user related biometric data).

The biometrics reading subsystem 140 may comprise suitable circuitry, interfaces, logic, and/or code for obtaining biometrics related data associated with a user of the electronic device 100. In this regard, biometrics data may comprise sensory information relating to distinctive, measurable features and/or characteristics, which collectively may uniquely identify a person. Accordingly, the biometrics reading subsystem 140 may comprise a plurality of suitable input devices, particularly sensors, which may be configured to read or obtain biometric data. Example of input devices or sensors that may be used in collecting or obtaining biometric data may comprise cameras, scanners, touchscreen, touchpads, microphones and the like. The biometric data may correspond to a plurality of biometric identifiers of various types. For example, biometric data may comprise information relating to physical, physiological, mental, or behavioral identifiers. Examples of biometric data may comprise, for example, data relating to fingerprint, facial recognition, iris recognition, retinal scan, and/or voice recognition, speech patterns, use patterns (e.g., signature, scribble, and/or swipe pattern(s), or timing of keystrokes), and the like.

In operation, the electronic device 100 may be utilized (e.g., by a device user) to perform, execute and/or run various functions, applications or services, such as using pre-configured instructions and/or based on real-time user instructions or interactions. For example, the electronic device 100 may support and/or may be used for communication services (e.g., voice calls, Internet access, text messaging, etc.), for playing video and/or audio content, gaming, email applications (and/or similar type of web based communications), and/or networking services (e.g., WiFi hotspot, Bluetooth piconet, and/or active 3G/4G/femtocell data channels). Use of the electronic device 100 may entail, in some instances, access and/or use of data, which may be maintained in the electronic device 100 and/or may be retrieved from other (local or remote) systems or devices.

In some instances, it may be desirable to limit and/or control access to particular data, functions or services in the electronic device 100. In this regard, particular data available in or accessible through the electronic device 100 may be associated with particular user(s), who may need (or desire) to prevent access to that data to others. For example, data accessible in or through the electronic device 100 may be, for example, copyrighted (thus requiring limiting its access or use to only authorized users), may comprise confidential information (e.g., personal or financial information), or the like. Accordingly, the electronic device 100 may be configured to implement various measures to guard against and/or prevent unwanted access of particular data, functions or services. For example, accessing particular data, functions or services in the electronic device 100 may be subject to secure access controls, which may require or necessitate authenticating the user requesting access to the data, functions or services before access to the data, functions or services is allowed. This may be achieved, for example, by requiring users seeking access to particular data or content to provide information that may sufficiently allow validating or authenticating them. For example, user authentication measures may require users requesting access to particular data, functions or services to provide predetermined information. For example, secure access may require users to provide credentials establishing or verifying their identities. In this regard, such credentials may be known only to the authorized user(s), and as such only legitimate users may be able to provide these credentials (e.g., as part of a login process) to obtain access. In some instances, encryption may be used to secure data. In this regard, secure devices and/or systems (e.g., the electronic device 100) may be configured to encrypt information to make it unreadable to any third party that may not be intended as authorized user (e.g., someone who gains unauthorized access to the system/device). Thus, decrypting data (that has been encrypted) would require an encryption key which would be known only by authorized users.

With heightened security concerns nowadays, information required for gaining authorized access have become increasingly complex and/or long, making it difficult for users to always remember that information correctly and/or making it inconvenient to provide (e.g., enter) that information whenever access to protected data, functions or services is desired (e.g., too many passwords to remember, encryption keys are too long or complex to remember or enter correctly, etc.). For example, with passwords, users nowadays may have many passwords (or pins), which may be used for accessing different devices, systems or services (e.g., work computer, our phone, our home computer, our bank account, and the various websites we use for shopping). As a result, users may resort to selecting weak or easily guessed passwords, or writing them down where an attacker can find them.

Accordingly, in various implementations, biometric data may be utilized to generate and/or configure ‘access’ parameters which may be used for enabling secure but convenient access to protected data, functions or services. In this regard, the access parameters may be used to overcome (or attempt to overcome) applicable barriers preventing a user attempting to gain access from accessing desired data, functions or services. For example, the biometric based access parameters may comprise encryption keys, which may be used in encrypting (and subsequently attempting to decrypt) to-be-protected data.

The use biometrics based values to generate access parameters may pose some challenges. In this regard, one particular challenge is that the biometric based access parameter generally must be invariant, yet it is difficult to find strictly invariant biometrics measures. For example, particular biometrics identifiers or characteristics may vary (for the same person) due to changes with the person, the sensors, and/or environment. Faces may vary, for example, in appearance due to changes in facial expression, lighting, camera difference, viewing angle, and day to day variations such as weight gain, tanning, freckling, sweating, etc. Similarly, for some individuals eye colors may not be always definitive (e.g., some persons' eyes may appear green in certain lighting conditions and hazel brown in other lighting conditions). While the biometrics analysis mechanisms (e.g., facial recognition) may be configured to allow for some variations to be factored out, these variations may ultimately not be discounted completely. Accordingly, in some implementations, the access parameter generation may be configured to allow for some flexibility—e.g., an access parameter generated for a person attempting access may be checked against multiple access parameters that represent similar appearance.

An example implementation in which biometric based encryption keys are used is described in more detail with respect to FIG. 2, for example. Nonetheless, while the implementation in the following figure is described with respect to encryption/decryption keys, it should be understood that the disclosure is not so limited, and other forms or types of access parameters may be generated and/or used based on biometric data in substantially similar manner.

FIG. 2 is a block diagram illustrating an example of interactions while controlling access to an electronic device using unique access parameters that are generated based on biometric data. Referring to FIG. 2, there is shown the electronic device 100 of FIG. 1.

The biometric based key generation may comprise use (e.g., as key bits) of discrete-valued representations of biometric data that may be obtained by the electronic device 100, such as via the biometrics reading subsystem 140. For example, the obtained biometric data may comprise such biometric identifiers (or characteristics or features thereof) as a person's face (image), person's fingerprint, iris scan, etc. Once the biometric data is obtained, each particular biometric identifier or characteristic thereof may be assigned a corresponding value, and each value may be represented discretely—e.g., as one or more bits, with these bits (corresponding to all the values of all the biometric identifiers or characteristics) being used in creating a user-specific (due to the uniqueness of each individual's biometrics) key that would make direct attacks against the key difficult (i.e. hard to duplicate by unauthorized users). In some instances, the biometric based values may be combined with other forms of user identification, to create a stronger combined key. For example, in an implementation, user-input (e.g., password, passphrase, and the like) may be combined with biometric based values in generating at least some of the user-specific key bits.

The size of the biometric based discrete value (e.g., number of bits) that may be used in the key generation may depend on the number of biometric identifiers, and the size of the discrete value corresponding to each biometric identifier or measurement. For example, biometric reading may be configured to obtain the following identifiers: gender, age, eye color, fingerprint, and voice. Each of these identifiers may then be mapped to a discrete value of defined size. For example, the person gender may be mapped to 1-bit discrete value (e.g., ‘0’ for male, ‘1’ for female). The person's age may be mapped to a discrete values based on classification of a number of age buckets, corresponding to particular age ranges. For example, there may be 8 age buckets (e.g., 0-9, 10-19, 20-29, 30-39, 40-49, 40-49, 50-59, and 60 or more—i.e., actual buckets may not be of identical length), thus resulting in mapping of person's age to 3-bits discrete value. With fingerprints, various points in the fingerprints may be classified, and bits may be generated from their bucketed properties, such as whether arch, loop, or whorl predominated in different physical regions of a finger or different fingers. Eye color may also be mapped to discrete value based on matching of the detected eye color with one of available classifications. For example, the eye color may be mapped into 2-bit discrete value, may be generated based on classification of a person's eye color into one of black, brown, blue, or green). Voice may also be mapped to discrete value based on classification of particular properties (e.g., 2-bit discrete values may be generated based on classification of a person's voice into one of Bass, Tenor, Alto, or Soprano).

The use of biometrics based values to generate encryption keys may pose some challenges. In particular, while an encryption key must generally be invariant, it may be difficult to obtain strictly invariant biometrics measures and thus the corresponding biometric based keys may vary. Accordingly, the encryption key generation may be configured to allow for some flexibility and/or degree of acceptable variation—i.e., different biometrics readings may be allowed to result in the same key. In this regard, there may be a tradeoff between key strength and flexibility of the key generation. In other words, configuring the key generation to allow for generation of similar keys from different readings may come at the expense of the reliability of the key (i.e., a possibility of key being valid from biometric reading of another person). For example, the discrete value mapping may be configured such that biometrics features or measurements thereof may yield similar values even when the underlying features may vary (within pre-determined, acceptable ranges). In this regard, the precision of the mapping between the biometrics data and the resultant key (particularly the mapping between the biometric identifiers and corresponding discrete values) may be configured to incorporate a measure of inaccuracy of the match (i.e., required degree of similarity in features needed for positive match of different readings). In this regard, the larger the size of a discrete value corresponding to a biometric identifier, the more accurate the match may need to be (e.g., with 2-bit eye color mapping, any hue of green would result in the same value, whereas with 4-bit eye, different hues of green would result in different values). Another consideration that may affect the discrete value mapping is the classification of edge cases—i.e., readings that would fall near edge between adjacent buckets. For example, somebody who is 29 may be in either the 20-29 or 30-39 bucket, depending on the accuracy of the classifier). In some implementation, the discrete value mapping applied during the key generation may be adjusted, such as based on user input specifying desired degree of precision (or key strength).

FIG. 3 is a block diagram illustrating different ways for combining user-input and biometrics based data when generating access parameters. Referring to FIG. 3, there is shown a biometrics based portion 310 and a user-input based portion 320.

The biometric based portion 310 may comprise values (e.g., set of bits) corresponding to values that are generated based on biometrics data associated with particular user, substantially as described with respect to FIGS. 1 and 2 for example. The user-input based portion 320 may comprise values (e.g., alphanumerical values) that are provided by a user (e.g., a password or passphrase), substantially as described with respect to FIGS. 1 and 2 for example.

The biometrics based portion 310 and the user-input based portion 320 may be combined when generating user-specific access parameters. In this regard, the user-specific access parameters may be configured and/or utilized as encryption keys which may be used in encrypting and decrypting data, thus providing protection thereof by ensuring that only corresponding authorized user(s) would gain access to the data. The biometrics based portion 310 and the user-input based portion 320 may be combined in various manners. For example, as shown in FIG. 3, a user-specific access parameter 330 may be generated based on simply concatenating (e.g., back-to-back) the biometrics based portion 310 and the user-input based portion 320.

In other implementations, however, the biometrics based portion 310 and the user-input based portion 320 may be combined in more complex manner for added security. For example, as shown in FIG. 3, a user-specific access parameter 340 may be generated based on hashing and/or interleaving parts of the biometrics based portion 310 and the user-input based portion 320. In other words, rather than simply incorporating the biometrics based portion 310 and the user-input based portion 320 in whole into the user-specific access parameter 340, one or both of the biometrics based portion 310 and the user-input based portion 320 may be partitioned in a plurality of sections, and the sections may then be incorporated into the user-specific access parameter 340. In this regard, the manner by which the biometrics based portion 310 and the user-input based portion 320 may be partitioned and/or the resultant sections are incorporated into the user-specific access parameter 340 may be selected and/or configured, and may vary from user to user.

In some implementations, the user-specific access parameters (e.g., parameters 330 and 340) generated from combining of biometric based portions and user-input based portions may also comprise additional sections, incorporating other values that may be generated by other means (e.g., using some randomization engine, sensory data obtained by the device, etc.). In this regard, the additional sections may be used for added security and/or to ensure that the generated user-specific access parameters have certain length, such as mandated by the intended use (e.g., having 128-bits, 192-bits or 256-bits when used as AES encryption key). The disclosure, however, is not so limited, and in some instances, the user-specific access parameters may simply comprise only the biometrics based portion 310 and the user-input based portion 320.

FIG. 4 is a flow chart that illustrates a process for generating a user-specific, unique access parameter that may be used in secure access. Referring to FIG. 4, there is shown a flow chart 400 comprising a plurality of steps that may be performed by a device (e.g., using an electronic device, such as the electronic device 100) for generating or configuring user-specific, unique access identifiers.

In step 402, biometric data associated with an authorized user may be obtained (e.g., using suitable biometric sensors). In step 404, biometrics based values, based on the obtained biometric data may be generated. In this regard, biometric based values may be generated using pre-defined value ranges for each of the biometric identifiers (biometric feature or characteristics thereof) in the obtained biometric data, substantially as described with respect to FIGS. 1 and 2 for example. In step 406, user-input, for use in conjunction with secure access operations, may be obtained from the user. The user-input may comprise, for example, a password, a passphrase, and the like. In step 408, a user specific, unique access parameter may be generated based on the obtained user input and the biometrics based values generated based on the obtained biometric data. For example, the access parameter may be generating by combining the user-input and the biometric values, substantially as described with respect to FIG. 3 for example. In step 410, the generated unique access parameter may be used to secure particular functions and/or data (e.g. content) that are to be accessed only by the user. For example, in instances where the access parameter is utilized as encryption key, the access parameter may be utilized in encrypting the to-be-secured data.

FIG. 5 is a flow chart that illustrates a process for secure access based on biometric data and user-input. Referring to FIG. 5, there is shown a flow chart 500 comprising a plurality of steps that may be performed by a device (e.g., using an electronic device, such as the electronic device 100) controlling and/or allowing access based on user-specific unique access identifiers.

In step 502, biometric data associated with a user attempting to gain access to protected function(s) and/or data (i.e., ‘requester’) may be obtained (e.g., using suitable biometric sensors). In step 504, biometrics based values, based on the obtained biometric data may be generated, substantially as described with respect to FIGS. 1 and 2 for example. In step 506, user-input (e.g., password or passphrase) that is to be utilized in generating access parameters may be requested and obtained from the requester. In step 508, a requester access parameter may be generated based on the obtained user-input and the biometrics based values generated based on the obtained biometric data, substantially as described with respect to FIG. 3 for example.

In step 510, the generated requester access parameter may be compared with a previously configured secure access parameter (for use in accessing the particular function(s) and/or data), to determine if the parameters are sufficiently similar. In this regard, the comparison and/or the determination of whether the parameters are similar may be configured to account for a tolerated degree of variation or dissimilarity. The tolerated variation or dissimilarity may be determined based on the similarity thresholds, for example, which may be considered as part of the comparison. Alternatively, the acceptable measures of dissimilarity may be incorporated into the parameter generation (e.g., by configuring or modifying the value ranges used when mapping the biometric identifiers to corresponding values).

In instances where the parameters (the requester access parameter and the secure access parameter) are deemed to be sufficiently similar, the process may proceed to step 512, where the requester may be granted access to the protected function(s) and/or data. Returning to step 510, in instances where the parameters are deemed to not be sufficiently similar, the process may proceed to step 514, where the requester may be deemed to be an unauthorized, non-intended user, and thus is denied access to the protected function(s) and/or data. In some implementations, requesters identified as unauthorized, non-intended users may be maintained for future use (e.g., to enable deny access directly and/or to notify authorized user of the attempts to gain access). It is noted that the steps 510-514 may sometimes be implemented by simply attempting to use the generated requester access parameter to ‘unlock’ protected secured functions and/or data rather than comparing the parameters. For example, where the secure access parameter is utilized as an encryption key, the requester access parameter may simply be utilized in attempting to decrypt the encrypted data, which should fail unless the parameters sufficiently match.

Other implementations may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the steps as described herein for using biometrics to generate encryption keys.

Accordingly, the present method and/or system may be realized in hardware, software, or a combination of hardware and software. The present method and/or system may be realized in a centralized fashion in at least one computer system, or in a distributed fashion where different elements are spread across several interconnected computer systems. Any kind of computer system or other system adapted for carrying out the methods described herein is suited. A typical combination of hardware and software may be a general-purpose computer system with a computer program that, when being loaded and executed, controls the computer system such that it carries out the methods described herein.

The present method and/or system may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present method and/or apparatus has been described with reference to certain implementations, it will be understood by those skilled in the art that various changes may be made and equivalents may be substituted without departing from the scope of the present method and/or apparatus. In addition, many modifications may be made to adapt a particular situation or material to the teachings of the present disclosure without departing from its scope. Therefore, it is intended that the present method and/or apparatus not be limited to the particular implementations disclosed, but that the present method and/or apparatus will include all implementations falling within the scope of the appended claims.

What is claimed is:

1. A method, comprising:
obtaining by an electronic device, biometrics related data associated with a user, wherein the biometrics related data comprises a plurality of biometric identifiers that uniquely identify the user;
generating by the electronic device a plurality of biometric based values, wherein:
the plurality of biometric based values is generated based on assigning of an associated value to each of the plurality of biometric identifiers in the obtained biometric data, and
for each of the plurality of biometric identifiers, a range of valid values is defined based on a type of biometric identifier and a specified degree of accuracy for the biometric identifier; and
configuring in the electronic device, based on the assigned associated values corresponding to the plurality of biometric identifiers, a secure access parameter associated with the user, for use in granting access to data using the electronic device, wherein:
the secure access parameter comprises at least a first portion that comprises at least one of the plurality of biometric based values and a second portion that is based on a user identification input.

2. The method of claim 1, wherein each of the plurality of biometric identifiers corresponds a biometric feature or a characteristic associated with a biometric feature.

3. The method of claim 1, wherein the first portion and the second portion of the secure access parameter are concatenated.

4. The method of claim 1, wherein the first portion and the second portion of the secure access parameter are interleaved.

5. The method of claim 1, comprising granting access to the electronic device by:
obtaining by the electronic device, a second biometrics related data associated with a person requesting access to the electronic device;
generating a requester access parameter based on the second biometrics related data, wherein the requester access parameter comprises a plurality of values corresponding to one or more of a plurality of biometric identifiers in the second biometrics related data and an input parameter provided by the person; and
determining when to grant access based on comparing of the requester access parameter with the secure access parameter.

6. The method of claim 5, comprising allowing for a maximum measure of dissimilarity for the comparing, the maximum measure of dissimilarity being determined, as least in part, based on the specified degree of accuracy associated with each biometric identifier.

7. The method of claim 1, wherein the granting of access to the electronic device comprise enabling access to data stored in or access via the electronic device.

8. The method of claim 7, wherein the enabling of access to data stored in or access via the electronic device comprises enabling decryption of the data when the data is encrypted.

9. The method of claim 1, wherein the secure access parameter comprises an encryption key that is used in encrypting and decrypting data access in or through the electronic device.

10. The method of claim 1, wherein the user identification input comprises a password.

11. A system, comprising:
an electronic device that is operable to:
obtain biometrics related data associated with a user, wherein the biometrics related data comprises a plurality of biometric identifiers that uniquely identify the user;
generate a plurality of biometric based values, wherein:
the plurality of biometric based values is generated based on assigning of an associated value to each of the plurality of biometric identifiers in the obtained biometric data, and
for each of the plurality of biometric identifiers, a range of valid values is defined based on a type of biometric identifier and a specified degree of accuracy for the biometric identifier; and
configure based on the assigned associated values corresponding to the plurality of biometric identifiers, a secure access parameter associated with the user, for use in granting access to data using the electronic device, wherein:
the secure access parameter comprises at least a first portion that comprises at least one of the plurality of biometric based values and a second portion that is based on a user identification input.

12. The system of claim 11, wherein each of the plurality of biometric identifiers corresponds a biometric feature or a characteristic associated with a biometric feature.

13. The system of claim 11, wherein the first portion and the second portion of the secure access parameter are concatenated.

14. The system of claim 11, wherein the first portion and the second portion of the secure access parameter are interleaved.

15. The system of claim 11, wherein the electronic device is operable to grant by:
obtaining by the electronic device, a second biometrics related data associated with a person requesting access to the electronic device;
generating a requester access parameter based on the second biometrics related data, wherein the requester access parameter comprises a plurality of values corresponding to one or more of a plurality of biometric identifiers in the second biometrics related data and an input parameter provided by the person; and
determining when to grant access based on comparing of the requester access parameter with the secure access parameter.

16. The system of claim 15, wherein the electronic device is operable to allow for a maximum measure of dissimilarity for the comparing, the maximum measure of dissimilarity being determined, as least in part, based on the specified degree of accuracy associated with each biometric identifier.

17. The system of claim 11, wherein the granting of access to the electronic device comprise enabling access to data stored in or access via the electronic device.

18. The system of claim 17, wherein the enabling of access to data stored in or access via the electronic device comprises enabling decryption of the data when the data is encrypted.

19. The system of claim 11, wherein the secure access parameter comprises an encryption key that is used in encrypting and decrypting data access in or through the electronic device.

20. The system of claim 11, wherein the user identification input comprises a password.
